(19) United States
(12) Patent Application Publication
(10) Pub. No.: US 2024/0213602 A1
(43) Pub. Date: Jun. 27, 2024

(54) BATTERY PACK

(71) Applicant: HONDA MOTOR CO., LTD., Tokyo (JP)

(72) Inventors: Naoki NOZOE, Tokyo (JP); Ryo Fujii, Tokyo (JP); Tatsuhiko Tanaka, Tokyo (JP); Eiki Hirose, Tokyo (JP); Hitoshi Tsukuda, Tokyo (JP)

(73) Assignee: HONDA MOTOR CO., LTD., Tokyo (JP)

(21) Appl. No.: 18/541,837

(22) Filed: Dec. 15, 2023

(30) Foreign Application Priority Data
Dec. 27, 2022 (JP) 2022-210186

(51) Int. Cl. H01M 50/236; B60K 1/04; H01M 50/249; H01M 50/262

(52) U.S. Cl. CPC H01M 50/236; B60K 1/04; H01M 50/249; H01M 50/262; B60K 2001/0438; H01M 2220/20

(57) ABSTRACT

A battery pack is disposed below a floor panel of a vehicle and attached to a vehicle body. The battery pack incudes a battery, and a case including a side wall at a peripheral edge and housing the battery. The case includes a protruding portion that is provided at an outer side surface of the side wall and protrudes outward of the case. The protruding portion includes a case fixing portion fixed to the vehicle body, and a clamped portion sandwiched by a jig in an upper-lower direction when the battery pack is attached to the vehicle body.

### CROSS-REFERENCE TO RELATED APPLICATIONS

This application is based on and claims priority under 35 USC 119 from Japanese Patent Application No. 2022-210186 filed on Dec. 27, 2022, the entire content of which is incorporated herein by reference.

### TECHNICAL FIELD

The present disclosure relates to a battery pack mounted on a vehicle.

### BACKGROUND ART

In recent years, researches and developments have been conducted on a secondary battery which contributes to improvement in energy efficiency in order to allow more people to have access to affordable, reliable, sustainable, and advanced energy.

As a drive source of a vehicle is electrified, a battery that supplies power to a motor or the like is mounted on the vehicle. The battery is mounted below a floor panel of the vehicle as a battery pack housed in a case. (For example, JP2021-125430A and JP2021-140931A).

As an output of the battery increases, the battery pack becomes large and heavy. When the battery pack is attached to a vehicle body by using a jig, it is necessary to sufficiently secure rigidity of the case so as not to deform due to its own weight.

### SUMMARY OF INVENTION

The present disclosure provides a battery pack capable of improving rigidity of a case.

An aspect of the present disclosure relates to a battery pack disposed below a floor panel of a vehicle and attached to a vehicle body, the battery pack including:
a battery; and
a case including a side wall at a peripheral edge and housing the battery,
in which the case includes a protruding portion that is provided at an outer side surface of the side wall and protrudes outward of the case, and
the protruding portion includes:
   a case fixing portion fixed to the vehicle body; and
   a clamped portion sandwiched by a jig in an upper-lower direction when the battery pack is attached to the vehicle body.

According to the present disclosure, it is possible to improve rigidity of the case.

### BRIEF DESCRIPTION OF DRAWINGS

Exemplary embodiment(s) of the present invention will be described in detail based on the following figures, wherein:

FIG. 1 is a perspective view of a battery pack 1 according to an embodiment of the present disclosure;

FIG. 2 is a perspective view of the battery pack 1 from which a cover 6 is removed:

FIG. 3 is a top view of a case 5;

FIG. 4 is an enlarged view of a protruding portion 55 (first protruding portion 55A) provided on a front side of a right wall 51c of the case 5;

FIG. 5 is a cross-sectional view taken along a line A-A in FIG. 3;

FIG. 6 is a cross-sectional view taken along a line B-B in FIG. 3;

FIG. 7 is a cross-sectional view taken along a line C-C in FIG. 3;

FIG. 8 is a cross-sectional view taken along a line D-D in FIG. 3; and

FIG. 9 is a view illustrating a modification in which an upper surface 57a of a clamped portion 57 includes an inclined surface.

### DESCRIPTION OF EMBODIMENTS

Hereinafter, an embodiment of a battery pack of the present disclosure will be described with reference to the accompanying drawings. The drawings are viewed in a direction of reference numerals. Further, in order to simplify and clarify description in the present specification and the like, a front-rear direction, a left-right direction, and an upper-lower direction are described according to a direction viewed from a driver of a vehicle. The drawings show a front side of the vehicle as Fr, a rear side of the vehicle as Rr, a left side of the vehicle as L, a right side of the vehicle as R, an upper side of the vehicle as U. and a lower side of the vehicle as D. Further, the left-right direction is also referred to as a vehicle width direction.

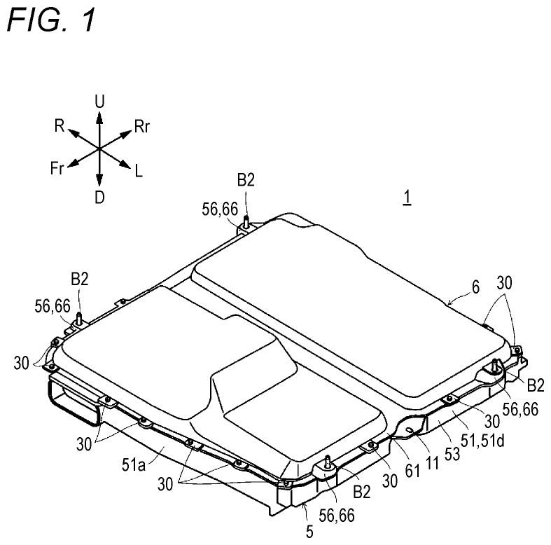

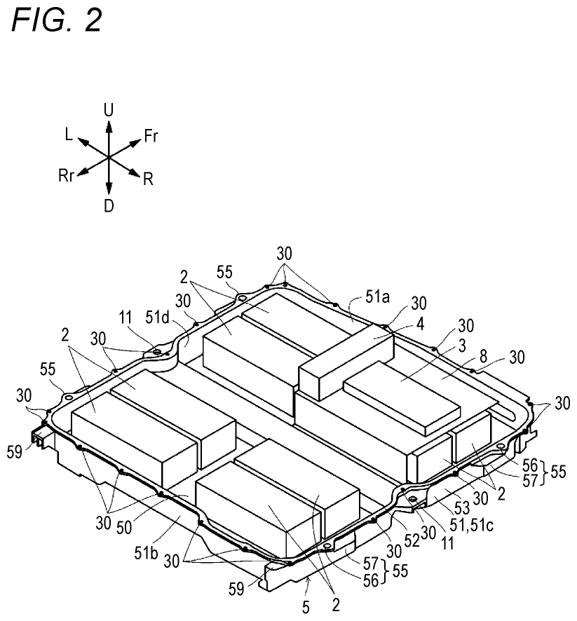

As shown in FIGS. 1 and 2, a battery pack 1 according to the present embodiment includes a plurality of (eight in the present embodiment) battery modules 2, a battery electronic control unit (ECU) 3, a junction board 4, a case 5 that houses the plurality of battery modules 2, the battery ECU 3, and the junction board 4, and a cover 6 that covers the case 5 from above. Although illustration is omitted, the battery pack 1 is mounted on an electric vehicle such as an electric automobile or a hybrid electric automobile, and supplies power to an electric motor serving as a drive source. The battery pack 1 is disposed below a floor panel of the vehicle, and attached to a vehicle body. In FIG. 2, illustration is omitted for electrical wiring (for example, wiring via a bus bar) of electrode terminals of the plurality of battery modules 2, the battery ECU 3, and the junction board 4.

The battery module 2 is configured by laminating a plurality of battery cells, and disposed in the case 5 such that a lamination direction (longitudinal direction) is the vehicle width direction. The four battery modules 2 are disposed on a front side, and the four battery modules 2 are disposed on a rear side with respect to a center of the case 5 in the front-rear direction. More specifically, on the front side of the case 5, the two battery modules 2 are disposed side by side in the front-rear direction on a left side, and similarly, the two battery modules 2 are disposed side by side in the front-rear direction on a right side. Further, on the rear side of the case 5, the two battery modules 2 are disposed side by side in the front-rear direction on a left side, and similarly, the two battery modules 2 are disposed side by side in the front-rear direction on a right side.

The battery ECU 3 controls charging and discharging of the battery modules 2, and includes a processor, a memory, an interface, and the like. The battery ECU 3 is disposed via a bracket 8 above the two battery modules disposed on the front side and the right side in the case 5.

The junction board 4 electrically connects the battery modules 2 to an external device (not shown), and includes a wiring component where charging power and discharging power of the battery modules 2 flow. The junction board 4 is disposed at a center on a front side in the case 5.

The case 5 is formed in a substantially square shape in a top view. The case 5 includes a bottom wall 50 where the battery modules 2 are placed, and a side wall 51 provided on a peripheral edge of the bottom wall 50. The side wall 51 includes a front wall 51a, a rear wall 51b, a right wall 51c, and a left wall 51d.

The cover 6 is formed in a substantially square shape in a top view, and has a size substantially the same as that of the case 5. The cover 6 is attached to the side wall 51 of the case 5 from above via a sealing member 7 (see FIGS. 5 to 8).

When the attachment of the cover 6 to the case 5 is described, fastening portions 30 that fasten the cover 6 to the case 5 are provided at an upper surface 52 of the side wall 51 of the case 5 and a lower surface 62 of a peripheral edge portion 61 of the cover 6 (see FIGS. 5 to 8). A plurality of fastening portions 30 are provided. Each fastening portion 30 has a hole through which a fastening member B1 such as a bolt can be inserted, and for example, the hole of the fastening portion 30 of the case 5 is a bolt hole. The upper surface 52 of the side wall 51 and the lower surface 62 of the cover 6 face each other, and the fastening member B1 is inserted into the hole of the fastening portion 30 from above to fasten the cover 6 to the case 5 as shown in FIG. 7. In the following description, the upper surface 52 of the side wall 51 and the lower surface 62 of the cover 6 are also referred to as a mating surface 52 of the side wall 51 of the case 5 and a mating surface 62 of the cover 6, respectively.

As shown in FIGS. 1 to 4, case fixing portions 56 fixed to the vehicle body are provided in an outer side surface 53 of the side wall 51 of the case 5. A plurality of (four in the present embodiment) case fixing portions 56 are provided along a peripheral edge of the case 5. Specifically, the four case fixing portions 56 are provided on a front side of the right wall 51c, a rear side of the right wall 51c, a front side of the left wall 51d, and a rear side of the left wall 51d.

As shown in FIGS. 1 and 8, the mating surface 62 of the cover 6 is provided with a cover fixing portion 66 fixed to the vehicle body in conjunction with the case fixing portion 56. The cover fixing portion 66 is provided corresponding to the position where the case fixing portion 56 is provided, and a plurality of (four in the present embodiment) cover fixing portions 66 are provided along the peripheral edge portion 61 of the cover 6.

The case fixing portion 56 and the cover fixing portion 66 have holes through which a fastening member B2 such as a bolt can be inserted. The fastening member B2 is inserted into the holes of the case fixing portion 56 and the cover fixing portion 66 from below. At this time, the fastening member B2 passes through the cover fixing portion 66, and extends to the vehicle body (not shown) disposed above the cover fixing portion 66. The battery pack 1 is attached to the vehicle body by the fastening member B2 that passes through the case fixing portion 56 and the cover fixing portion 66 and extends upward.

The case 5 is provided with positioning holes 11 at a central position in the front-rear direction and on both sides in the vehicle width direction. When attaching the battery pack 1 to the vehicle body, for example, after pins or the like provided at the vehicle body are inserted into the positioning holes 11 to position the battery pack 1, the battery pack 1 is attached to the case fixing portions 56 and the cover fixing portions 66 by the fastening members B2.

As shown in FIGS. 1 to 4, the case 5 includes protruding portions 55 that are provided at the outer side surface 53 of the side wall 51 and protrude toward an outer side of the case 5. The protruding portion 55 includes the case fixing portion 56 described above and a clamped portion 57.

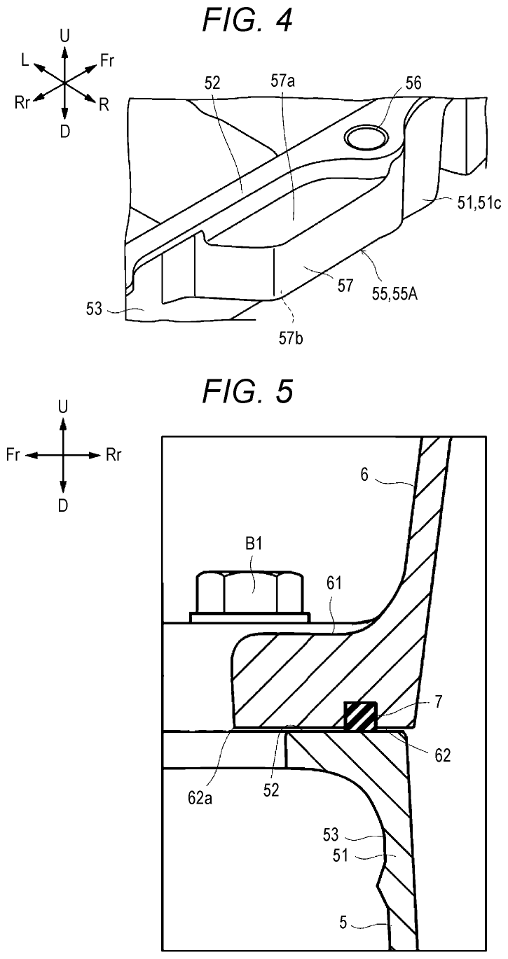

The clamped portion 57 is a portion sandwiched by a jig (not shown) in the upper-lower direction when the battery pack 1 is attached to the vehicle body. As shown in FIG. 4, the clamped portion 57 includes an upper surface 57a and a lower surface 57b. When attaching the battery pack 1 to the vehicle body from below, the clamped portion 57 is held by sandwiching the upper surface 57a and the lower surface 57b of the clamped portion 57 by the jig, and the battery pack 1 is supported.

The case fixing portion 56 and the clamped portion 57 are disposed adjacent to each other along a direction in which the outer side surface 53 of the side wall 51 extends, and are integrally provided as a portion that constitutes the protruding portion 55. The case fixing portion 56 is a highly rigid location, and the clamped portion 57 is provided at the protruding portion 55 together with the case fixing portion 56, thereby sharing high rigidity of the case fixing portion 56. Therefore, when the battery pack 1 is attached to the vehicle body by using the jig, rigidity of the case 5 can be sufficiently secured so as not to deform due to its own weight. Accordingly, when the clamped portion 57 is held by the jig, the battery pack 1 can be stably supported.

In a top view, the clamped portion 57 is larger than the case fixing portion 56. Therefore, a region occupied by the clamped portion 57 in the protruding portion 55 is increased, whereby the clamped portion 57 can be firmly held by the jig.

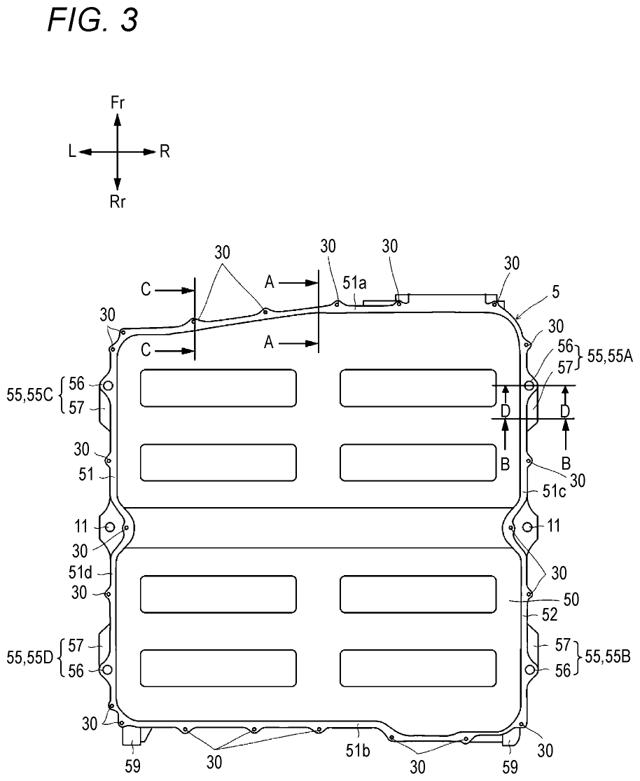

A plurality of (four in the present embodiment) protruding portions 55 are provided on both sides in the vehicle width direction (left-right direction). More specifically, as shown in FIG. 3, the protruding portion 55 includes a first protruding portion 55A and a second protruding portion 55B provided on the front side and the rear side with respect to a center of the case 5 at the right wall 51c of the case 5, and a third protruding portion 55C and a fourth protruding portion 55D provided on the front side and the rear side with respect to the center of the case 5 at the left wall 51d of the case 5. In this way, the clamped portion 57 of each protruding portion 55 is disposed in a well-balanced manner in the vehicle width direction and the front-rear direction of the battery pack 1. Therefore, when the battery pack 1 is attached to the vehicle body, the battery pack 1 can be more stably supported by the jig.

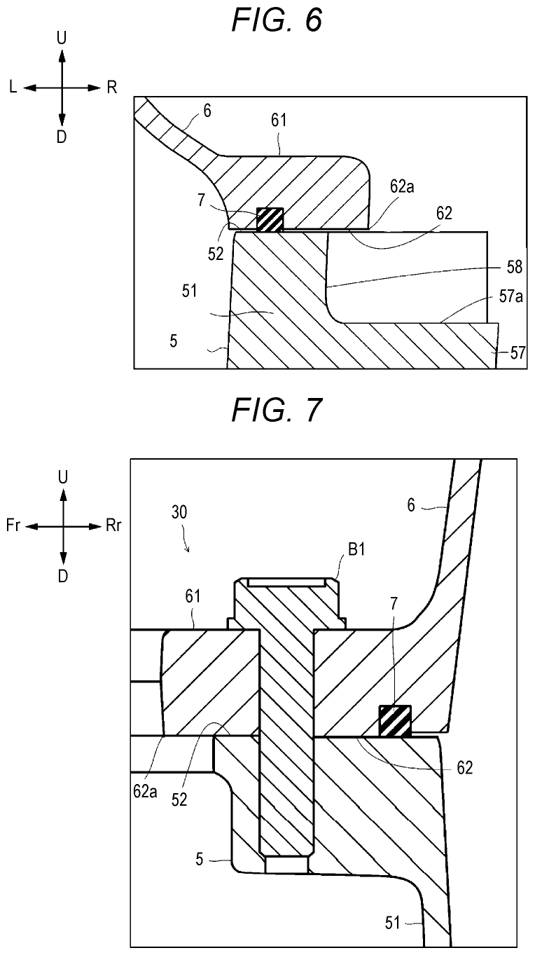

FIGS. 5 and 6 show a cross-sectional view taken along a line A-A and a cross-sectional view taken along a line B-B in FIG. 3. As shown in FIG. 5, an outer edge 62a of the mating surface 62 of the cover 6 is located outward of the mating surface 52 of the case 5. As shown in FIG. 6, at the position where the clamped portion 57 is provided, the upper surface 57a of the clamped portion 57 is lower than the mating surface 52 of the case 5, and a step portion 58 is provided between the upper surface 57a of the clamped portion 57 and the mating surface 52 of the case 5. With such a configuration, it is possible to prevent a liquid (for example, salt water) that flows from an upper surface of the cover 6 from entering between the mating surface 52 of the case 5 and the mating surface 62 of the cover 6.

The mating surface 62 of the cover 6 is formed flat in a horizontal direction up to the outer edge 62a. In other words, no step is formed in a portion of the mating surface 62 of the cover 6 located outward of the mating surface 52 of the case 5. With such a configuration, a liquid is unlikely to be held in the portion of the mating surface 62 of the cover 6 located outward of the mating surface 52 of the case 5. Therefore, it is possible to further prevent the liquid (for example, the salt water) that flows from the upper surface of the cover 6 from entering between the mating surface 52 of the case 5 and the mating surface 62 of the cover 6.

As shown in FIG. 8, the mating surfaces 52 and 62 of the case 5 and the cover 6 abut against each other at the case fixing portion 56 and the cover fixing portion 66. Similarly, as shown in FIG. 7, the mating surfaces 52 and 62 of the case 5 and the cover 6 abut against each other at the fastening portion 30. That is, the case 5 and the cover 6 are strongly fastened to each other at the case fixing portion 56, the cover fixing portion 66, and the fastening portion 30.

On the other hand, as shown in FIGS. 5 and 6, the mating surfaces 52 and 62 of the case 5 and the cover 6 are provided with a gap in a portion other than the case fixing portion 56, the cover fixing portion 66, and the fastening portion 30. The gap is, for example, a minute gap of 1 mm or less.

Even if the mating surfaces 52 and 62 abut against each other, a minute amount of liquid may enter between the mating surfaces 52 and 62. When a case where the mating surfaces 52 and 62 abut against each other is compared with a case where the mating surfaces 52 and 62 are provided with the gap therebetween, in the case where the mating surfaces 52 and 62 abut against each other, corrosion of the mating surfaces 52 and 62 is likely to progress when the liquid enters between the mating surfaces 52 and 62. Therefore, with the configuration in which the gap is provided between the mating surfaces 52 and 62, it is possible to prevent the progress of the corrosion of the mating surfaces 52 and 62.

As shown in FIG. 3, positions of outer edges of the first protruding portion 55A and the second protruding portion 55B provided on a right side in the vehicle width direction are aligned to be identical each other in the vehicle width direction. Similarly, positions of outer edges of the third protruding portion 55C and the fourth protruding portion 55D provided on a left side in the vehicle width direction are aligned to be identical each other in the vehicle width direction. With such a configuration, when there is an input of impact from the vehicle width direction, the input of the impact can be received in a well-balanced manner by the protruding portions 55 provided apart from each other in the front-rear direction. Therefore, the battery modules 2 disposed inside the battery pack 1 can be protected.

Further, a plurality of protrusions 59 are provided at the rear wall 51b of the case 5. In the present embodiment, two protrusions 59 are provided on both sides in the vehicle width direction. With such a configuration, when there is an input of impact from a rear side of the vehicle, the input of the impact can be received in a well-balanced manner by the protrusions 59 provided apart from each other on both sides in the vehicle width direction. The protrusions 59 may be provided at the front wall 51a of the case 5, or may be provided at both the front wall 51a and the rear wall 51b of the case 5.

### (Modification)

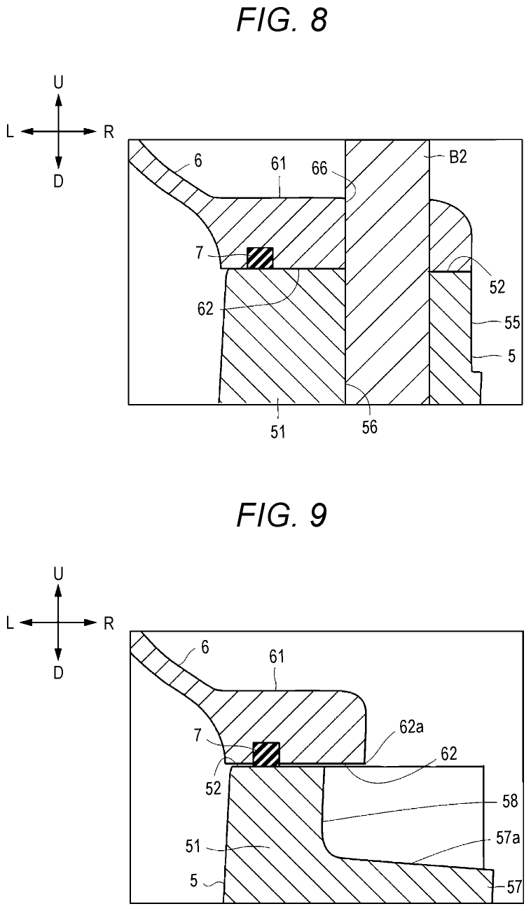

As shown in FIG. 9, the upper surface 57a of the clamped portion 57 may include an inclined surface inclined downward toward outside of the case 5. With such a configuration, it is possible to prevent a liquid that flows from an upper surface of the cover 6 to the upper surface 57a of the clamped portion 57 from accumulating on the upper surface 57a. The configuration is particularly effective in that when a height of the step portion 58 cannot be sufficiently secured, it is possible to further prevent the liquid from entering between the mating surface 52 of the case 5 and the mating surface 62 of the cover 6. The inclined surface of the upper surface 57a of the clamped portion 57 preferably has an inclination to an extent that sandwiching of the clamped portion 57 by the jig is not hindered.

Although an embodiment of the present disclosure has been described above with reference to the accompanying drawings, it is needless to say that the present invention is not limited to the embodiment. It is apparent that those skilled in the art may conceive of various modifications and changes within the scope described in the claims, and it is understood that such modifications and changes naturally fall within the technical scope of the present invention. Further, in a scope not departing from the gist of the invention, components in the embodiment described above may be freely combined.

In the present specification, at least the following matters are described. In parentheses, the corresponding components and the like in the embodiment described above are shown as an example, but the present invention is not limited thereto.
(1) A battery pack (the battery pack 1) disposed below a floor panel of a vehicle and attached to a vehicle body, the battery pack including:
a battery (the battery module 2), and
a case (the case 5) including a side wall (the side wall 51) at a peripheral edge and housing the battery,
in which the case includes a protruding portion (the protruding portion 55) that is provided at an outer side surface (the outer side surface 53) of the side wall and protrudes outward of the case, and
the protruding portion includes:
   a case fixing portion (the case fixing portion 56) fixed to the vehicle body; and
   a clamped portion (the clamped portion 57) sandwiched by a jig in an upper-lower direction when the battery pack is attached to the vehicle body.

According to (1), the clamped portion is provided at the protruding portion together with the case fixing portion, and shares high rigidity of the case fixing portion. Therefore, when the battery pack is attached to the vehicle body by using the jig, it is possible to sufficiently secure rigidity of the case so as not to deform due to its own weight. Therefore, it is possible to improve the rigidity of the case.
(2) The battery pack according to (1), further including:
a cover (the cover 6) configured to cover the case from above,
in which the side wall of the case and the cover each include mating surfaces (the mating surfaces 52 and 62) that mutually face via a sealing member (the sealing member 7), and
the cover includes a cover fixing portion (the cover fixing portion 66) provided at the mating surface, and fixed to the vehicle body in conjunction with the case fixing portion.

According to (2), the case and the cover can be fixed to the vehicle body at the case fixing portion and the cover fixing portion.
(3) The battery pack according to (2),
in which an outer edge (the outer edge 62a) of the mating surface of the cover is located outward of the mating surface of the case, and
an upper surface (the upper surface 57a) of the clamped portion is lower than the mating surface of the case, and a step portion (the step portion 58) is provided between the upper surface of the clamped portion and the mating surface of the case.

According to (3), since the outer edge of the mating surface of the cover is located outward of the mating surface of the case, it is possible to prevent a liquid that flows from the upper surface of the cover from entering between the mating surfaces.
(4) The battery pack according to (3).
in which the mating surface of the cover is formed flat in a horizontal direction up to the outer edge.

According to (4), the liquid is unlikely to be held in a portion of the mating surface of the cover located outward of the mating surface of the case, and it is possible to prevent the liquid that flows from the upper surface of the cover from entering between the mating surfaces.
(5) The battery pack according to any one of (2) to (4),
in which a fastening portion (the fastening portion 30) configured to fasten the cover to the case is provided at the mating surfaces of the case and the cover,
the mating surfaces of the case and the cover abut against each other at the case fixing portion, the cover fixing portion, and the fastening portion, and
the mating surfaces of the case and the cover are provided with a gap in a portion other than the case fixing portion, the cover fixing portion, and the fastening portion.

According to (5), the gap is provided in a portion of the mating surfaces of the case and the cover, whereby it is possible to prevent progress of corrosion of the mating surfaces.
(6) The battery pack according to any one of (1) to (5),
in which an upper surface of the clamped portion includes an inclined surface inclined downward toward outside of the case.

According to (6), it is possible to easily discharge the liquid that flows to the upper surface of the clamped portion.
(7) The battery pack according to any one of (1) to (6),
in which the protruding portions are provided on both sides in a vehicle width direction, and
the protruding portion includes:
   a first protruding portion (the first protruding portion 55A) and a second protruding portion (the second protruding portion 55B) provided at the side wall of the case on one side (right side) in the vehicle width direction, and provided on a front side and a rear side with respect to a center of the case in a front-rear direction; and
   a third protruding portion (the third protruding portion 55C) and a fourth protruding portion (the fourth protruding portion 55D) provided at the side wall of the case on other side (left side) in the vehicle width direction, and provided on the front side and the rear side with respect to the center of the case in the front-rear direction.

According to (7), since the first protruding portion to the fourth protruding portion are provided on both sides in the vehicle width direction and the front and rear sides in the front-rear direction, the clamped portions of the protruding portions are disposed in a well-balanced manner at the case. Therefore, when the battery pack is attached to the vehicle body, the battery pack can be more stably supported by a jig.
(8) The battery pack according to (7),
in which positions of outer edges of the first protruding portion and the second protruding portion are aligned to be identical each other in the vehicle width direction, and
positions of outer edges of the third protruding portion and the fourth protruding portion are aligned to be identical each other in the vehicle width direction.

According to (8), when there is an input of impact from the vehicle width direction, the input of the impact can be received in a well-balanced manner by the protruding portions.
(9) The battery pack according to any one of (1) to (8),
in which a plurality of protrusions (the protrusions 59) are provided on at least one of a front side or a rear side of the side wall of the case, and
the plurality of protrusions are provided on both sides in the vehicle width direction.

According to (9), when the impact is input from the front-rear direction, the input of the impact can be received in a well-balanced manner by the protrusions provided on both sides in the vehicle width direction.
(10) The battery pack according to any one of (1) to (9),
in which the clamped portion is larger than the case fixing portion in a top view.

According to (10), a region sandwiched by the jig can be sufficiently secured.

What is claimed is:

1. A battery pack disposed below a floor panel of a vehicle and attached to a vehicle body, the battery pack comprising:
a battery; and
a case including a side wall at a peripheral edge and housing the battery,
wherein the case includes a protruding portion that is provided at an outer side surface of the side wall and protrudes outward of the case, and
the protruding portion includes:
a case fixing portion fixed to the vehicle body; and
a clamped portion sandwiched by a jig in an upper-lower direction when the battery pack is attached to the vehicle body.

2. The battery pack according to claim 1, further comprising:
a cover configured to cover the case from above,
wherein the side wall of the case and the cover each include mating surfaces that mutually face via a sealing member, and
the cover includes a cover fixing portion provided at the mating surface, and fixed to the vehicle body in conjunction with the case fixing portion.

3. The battery pack according to claim 2,
wherein an outer edge of the mating surface of the cover is located outward of the mating surface of the case, and
an upper surface of the clamped portion is lower than the mating surface of the case, and a step portion is provided between the upper surface of the clamped portion and the mating surface of the case.

4. The battery pack according to claim 3,
wherein the mating surface of the cover is formed flat in a horizontal direction up to the outer edge.

5. The battery pack according to claim 2,
wherein a fastening portion configured to fasten the cover to the case is provided at the mating surfaces of the case and the cover,
the mating surfaces of the case and the cover abut against each other at the case fixing portion, the cover fixing portion, and the fastening portion, and
the mating surfaces of the case and the cover are provided with a gap in a portion other than the case fixing portion, the cover fixing portion, and the fastening portion.

6. The battery pack according to claim 1,
wherein an upper surface of the clamped portion includes an inclined surface inclined downward toward outside of the case.

7. The battery pack according to claim 1,
wherein the protruding portions are provided on both sides in a vehicle width direction, and
the protruding portion includes:
a first protruding portion and a second protruding portion provided at the side wall of the case on one side in the vehicle width direction, and provided on a front side and a rear side with respect to a center of the case in a front-rear direction; and
a third protruding portion and a fourth protruding portion provided at the side wall of the case on other side in the vehicle width direction, and provided on the front side and the rear side with respect to the center of the case in the front-rear direction.

8. The battery pack according to claim 7,
wherein positions of outer edges of the first protruding portion and the second protruding portion are aligned to be identical each other in the vehicle width direction, and
positions of outer edges of the third protruding portion and the fourth protruding portion are aligned to be identical each other in the vehicle width direction.

9. The battery pack according to claim 1,
wherein a plurality of protrusions are provided on at least one of a front side or a rear side of the side wall of the case, and
the plurality of protrusions are provided on both sides in the vehicle width direction.

10. The battery pack according to claim 1,
wherein the clamped portion is larger than the case fixing portion in a top view.
